(19) United States
(12) Patent Application Publication
(10) Pub. No.: US 2025/0200656 A1
(43) Pub. Date: Jun. 19, 2025

(54) PARTIAL AUTOMATED RECOURSE

(71) Applicant: MULTI SERVICE TECHNOLOGY SOLUTIONS, INC., Overland Park, KS (US)

(72) Inventors: Daniel Wayne ZIMMERMAN, Overland Park, KS (US); Daniel Joseph CATES, Overland Park, KS (US); Brandon Dean BLAYLOCK, Prairie Village, KS (US); Joshua Daniel COMPTON, Eskridge, KS (US); Steven Trevor BALDWIN, Melbourne (AU)

(21) Appl. No.: 18/893,584

(22) Filed: Sep. 23, 2024

Related U.S. Application Data
(63) Continuation-in-part of application No. 18/543,915, filed on Dec. 18, 2023.

(51) Int. Cl. G06Q 40/03; G06N 20/00

(52) U.S. Cl. CPC G06Q 40/03; G06N 20/00

(57) ABSTRACT

A computer-implemented method and system for authorizing user access to services provided by a first entity is disclosed. The method involves receiving a request to authorize a user, retrieving a plurality of user-related metrics from a database, generating a risk metric based on these metrics, and automatically determining the user's authorization based on the risk metric. The authorization decision involves a second entity assuming a portion of the risk for the services provided by the first entity and the first entity assuming a second portion of the risk for the services. The method further includes communicating the authorization decision to a graphical user interface, providing a clear indication of the user's authorized access.

### CROSS-REFERENCE TO RELATED APPLICATIONS

This application is a Continuation-in-Part of U.S. patent application Ser. No. 18/543,915, filed Dec. 18, 2023 and entitled “AUTOMATED RECOURSE”, the entire contents of which is incorporated herein in its entirety.

### BACKGROUND

Merchant credit applications are submitted by business entities to request trade credit for business-to-business transactions. Each merchant credit application uses a large amount of data retrieval from a variety of sources. Merchant credit applications may not be from existing or well-known business entities. Approval for credit is contingent on external sources of information related to an applicant.

### SUMMARY

At a high level, aspects described herein relate to systems and methods that process merchant credit applications. The present technological advance can absolve technological issues, which the merchant credit applications present based on their need for much internal and external data.

Credit application processes typically obtain information from various external sources, which often come in different formats, making it challenging to analyze and process. The sources for this information can change frequently, leading to additional complexities. Traditional methods for authorizing user access have been manual, time-consuming, and prone to errors. Moreover, once credit issuers make a decision, there's generally no recourse for merchants or applicants. This disclosure introduces a system that addresses these challenges. It centralizes the acquisition of data from multiple external sources, normalizing this data, and converting it into a single risk metric in real time. This allows merchants to assess an applicant's creditworthiness (e.g., in real-time) without seeing the comprehensive data, providing a more streamlined, adaptable, and efficient solution. Furthermore, this system permits merchants a say in the approval process, offering more flexibility in decision-making based on the risk metric, even if the applicant lacks ideal creditworthiness.

In one aspect, one or more media storing computer-readable instructions are disclosed. These instructions, when executed by one or more processors, facilitate several operations. Initially, a machine learning model is trained by processing one or more feature vectors to generate a risk metric associated with an applicant. The processor then automatically determines, based on this risk metric, that the applicant is authorized to use a first portion of services provided by a first entity, with a second entity assuming a first portion of risk and the first entity a second portion. The processor assigns a first recourse percentage to a first purchase and a second recourse percentage based on these risk portions. Upon receiving a request to authorize a second portion of services, the processor further determines the applicant's authorization for this second portion, where the second entity assumes a third portion of risk and the first entity a fourth portion. A third and fourth recourse percentage are assigned for subsequent purchases. Finally, the processor sends a command to a graphical user interface confirming the applicant's authorization to access these services.

Aspects disclosed herein provide a method tailored for a merchant credit application that includes: training a machine learning model to process feature vectors and generate a risk metric associated with an applicant. This training process enables a processor to automatically determine whether an applicant is authorized to use a first portion of services from a first entity, with risk assumptions split between the first and a second entity. Specific recourse percentages are assigned to purchases based on the divided risk. Following this, the processor receives and processes a request for additional services, evaluating and authorizing the use based on updated risk metrics, and assigning further recourse percentages accordingly. This entire process is coordinated through a graphical user interface which displays the authorization status to the relevant parties.

Additional aspects include a system comprising a processor configured to execute a credit application method. This method involves training a machine learning model to process feature vectors and generate a risk metric for an applicant. The processor uses this metric to authorize the applicant for a first set of services, allocating risk between the first and a second entity and assigning corresponding recourse percentages. When a request for additional services is received, the processor re-evaluates the authorization based on the existing risk metric, assumes additional risk portions for the new services, and assigns new recourse percentages. These operations culminate in an update to a graphical user interface that communicates the updated service authorization to the applicant.

This summary is intended to introduce a selection of concepts in a simplified form that is further described in the detailed description section of the present disclosure. It is neither intended to identify key or essential features of the claimed subject matter, nor is it intended to be an aid in determining the scope of the claimed subject matter. Additional objects, advantages, and novel features of the technology will be set forth in part in the detailed description that follows, and in part will become apparent to those skilled in the art upon examination of the present disclosure or learned through practice of the technology.

### BRIEF DESCRIPTION OF THE DRAWINGS

The present technology is described in detail below with reference to the attached drawing figures, wherein:

FIG. 1 is an example operating environment in which aspects of the present disclosure may be employed to process and authorize a merchant credit applicant;

FIG. 2 is an example computing device suitable for implementing aspects of the present disclosure, in accordance with an embodiment described herein;

FIG. 3 is an example process flow that can be performed by components of the operating environment of FIG. 1 and the computing device of FIG. 2, in accordance with an aspect described herein; and

FIG. 4 is a block diagram illustrating example operations that can be performed by the components of the operating environment of FIG. 1, in accordance with aspects described herein.

### DETAILED DESCRIPTION

Credit applications are submitted from a user to obtain credit that can be extended to that user by a credit issuer. In some cases, the applicant is a business that wishes to obtain credit to be used at a particular merchant. When the applicant provides information through the application process, the credit issuer may then use that information to obtain further information from external sources. Such information may be commercial credit information, personal credit information, uniform commercial code data, and office of foreign assets and control data. Each piece of information likely comes from a distinct external source that uses coordination of many application program interfaces and retrieval of a variety of different formatting of data. Some sources of the information may differ in a format they provide that information in, and, as such, external data must also be converted into usable, normalized data. Additionally, the incoming data and information may be large and confusing to analyze and process.

The sources of the information desired may also change at a rapid pace. For example, the commercial credit information may come from a credit monitoring service when the merchant credit applications are first being received. In the future, the commercial credit information may come from a different credit monitoring service. Additionally, the credit issuers can, in the future, request additional or different information than currently used for a trade credit to be issued to a merchant. As such, changes occurring to a merchant credit application processing software must be entirely rewritten to accommodate the new service.

With respect to existing technologies, such as merchant credit application processing software, the process of authorizing user access to services provided by a first entity often involved manual input into a spreadsheet, evaluation and decision-making by human administrators. This approach is time-consuming, prone to errors, and lacked consistency. It relied heavily on subjective judgments and limited factors, which could result in both false positive and false negative authorization decisions. Additionally, the process is not efficient enough to handle a large volume of user authorization requests, leading to delays and increased administrative overhead. As technology advanced and the number of users and services increased, the traditional technologies became increasingly inadequate and hindered the scalability and effectiveness of the authorization process. For example, even though some merchant credit application software engage in advanced algorithms that analyze the collected data and credit information to make automated decisions regarding the approval or rejection of credit applications, they still lack the ability to handle data comes in different formats. Furthermore, the existing technologies typically did not consider a comprehensive range of metrics associated with the user, resulting in a limited assessment of the user's risk profile. Without a holistic understanding of the user's risk factors, the authorization decisions were less accurate and failed to adapt dynamically to changing circumstances.

Merchants and financial institutions often find themselves ensnared in a labyrinth of data sources, including myriad websites, direct communications, and archaic databases, to gather essential details about financing offers and credit terms. This piecemeal approach triggers significant spikes in computer input/output (I/O) activities. Specifically, there's a surge in physical read/write activities on non-volatile disks during data operations, which not only is time-intensive and error-prone but also accelerates the wear and tear of system components. Additionally, computing devices that constantly tap into these scattered information resources face substantial computational costs. For instance, every initiated query (e.g., an SQL query) mandates the activation of an optimizer engine within the database manager module, aiming to formulate an optimal execution strategy. This entails calculations based on multiple parameters, such as cardinality and selectivity. Continually initiating this cycle to ascertain the most efficient plan for executing queries, especially when dealing with multiple credit applications, significantly diminishes system throughput and escalates network latency. When you factor in that most database relationships contain hundreds or even thousands of entries, this repetitive computation on vast data rows further curtails system performance and heightens latency. It becomes evident that the existing technologies are neither efficient nor nimble, highlighting a pressing need for a more consolidated, smart, and centralized solution in the financial landscape.

Additionally, in the current state of the art, once a credit issuer denies or approves an applicant, there is no recourse for the merchant or the applicant other than possibly an appeal. There is a need for a system that allows the merchant to be able to approve, partially or in full, the credit to be issued to the applicant for business purposes. For example, if an applicant is a long-standing client, the merchant may desire to extend the credit even though the applicant does not have great creditworthiness. By allowing the merchant to approve or deny the applicant, significant technological issues arise. The credit issuer must allow the merchant to view the creditworthiness of the applicant but may not wish for them to see the entirety of the external data. The current technology does not allow for this, and as such, a technological solution is provided herein. Furthermore, the current approach to shared credit risk is to put one creditor in a position of first loss. The disclosed approach creates a vested interest for any sized loss and effectively caps each account at the amount of loss each creditor is willing to accept. This innovation ensures that each party involved has a stake in the credit issued, thereby distributing the risk more equitably and efficiently.

The present disclosure provides methods of obtaining information about a credit applicant from external sources. These external sources are varied and may come in differing formats. The methods used herein convert this external data into a risk metric that incorporates the application and all externally obtained information. This allows the merchant user to conveniently analyze the risk associated with the applicant without viewing any potentially proprietary decision-making data. By converting the entire risk data into a single risk score or metric, the technological problem is solved.

Additionally, a centralized system is able to receive any non-standardized data from an external source and convert it to normalized data to be used in credit decision logic and generate a single risk metric. The system retrieves external data from a wide array of sources that uses the centralized integration system to be capable of interacting with multiple interfaces and programs. As such, the current technology provides the centralized integration service that houses application program interfaces that directly communicate with each of the external sources. The service is also able to retrieve and store data in normalized standards that may not come from the external sources. This is different from current systems that do not have the centralized integration system that communicates with the external sources and retrieves information from each of the many external sources and may potentially store dissimilar data structures in original non-standardized data structure(s).

Incorporating real-time processing into a centralized system as described would involve several enhancements to current technology. As data is received, the system normalizes and transforms it into a standardized format immediately, enabling on-the-fly integration into credit decision logic. This can be done using middleware or frameworks that support dynamic schema evolution to adapt to changes in data structures from the external sources. Additionally, risk metrics are calculated in real-time as new, non-standardized, data arrives, using decision logic for speed and efficiency. This can be done through the use of in-memory computing or real-time processing engines.

Relative to existing technologies and computer functionality, the methods of the present disclosure reduce network latency, reduce packet generation costs, and reduce computer input/output (I/O), among other computer function benefits. This embodiment streamlines the process by using a single service or server to communicate with external sources during credit application processing. This reduces the need to contact multiple hardware components over a computer network, enhancing efficiency. What this means is that fewer (or no) packets must be generated and sent over the computer network. Each time a service is contacted, for example, contents or payload of the request is typically supplemented with header information or other metadata within a packet in TCP/IP or other protocol networks. Accordingly, when this functionality is multiplied by all the services needed to obtain the desired data, there are network latency costs from repetitively generating the metadata and sending it over the computer network. However, as described above, in this technology, communication with external sources occurs using only the single service or the server, which means there are fewer packets to generate and fewer messages to traverse the computer network, thereby reducing network latency. This has a further technical effect of decreasing the computer I/O. With respect to the existing technologies, continuous communication with multiple services increases storage device I/O (for example, excess physical read/write head movements on non-volatile disk) because, with each communication or data packet sent, a computing system has to reach out to the storage device I/O to perform a read or write operation, which is error prone, and eventually wears on components, such as a read/write head. When multiplied by all the multiple service communication requirements, this causes excessive wear on the read/write head and causes excessive energy consumption and heat, which leads to other computational issues, such as memory errors. However, as described above, there are fewer (or no) times that embodiments perform I/O with the subject technology. Consequently, there is not as much wear and tear on the read/write head, and there is not as much energy consumption and heat generation, and hence the likelihood of memory errors is reduced.

Additionally, in some embodiments, the methods of the present disclosure improve computer security relative to existing technologies because the external sources are contacted and accessed using the single service rather than multiple services. In other words, the more times a data packet has to traverse the computer network (which occurs with existing technologies), the higher the likelihood that data will be sniffed or otherwise compromised. Sniffing is a process of monitoring and capturing all data packets passing through a given network. Attackers use sniffer code to capture data packets containing sensitive information, such as passwords, account information, and the like. However, as described above, some embodiments only use the single service rather than multiple services, which means there are less packets getting transmitted over the computer network, which consequently means that the data is less likely to be sniffed by attackers. The centralized integration service is also easily modifiable to adapt to changing external source code or systems since the centralized integration service is built based on the volatility-based decomposition architecture that allows for only a portion of the architecture to be changed at a time.

It will be realized that the method previously described is only an example that can be practiced from the description that follows, and it is provided to understand the technology and recognize its benefits. Additional examples are now described with reference to the figures.

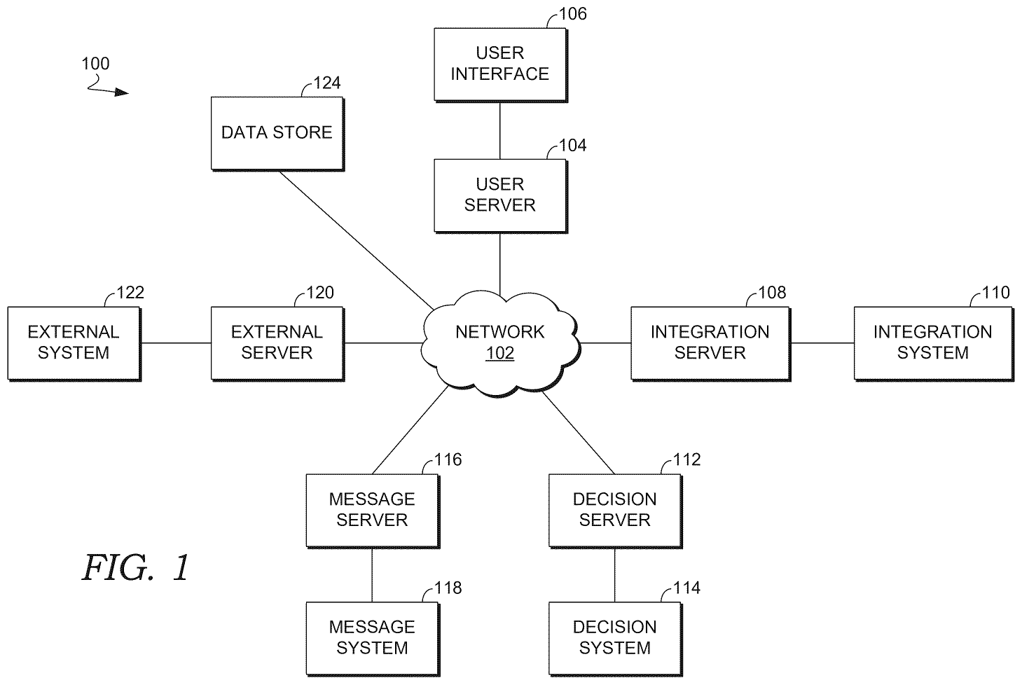

With reference now to FIG. 1, FIG. 1 is an example operating environment 100 in which aspects of the present disclosure can be employed to process and authorize a merchant credit application. As illustrated, the operating environment 100 comprises a network 102, a user server 104 associated with a user interface 106, an integration server 108 associated with an integration system 110, a decision server 112 associated with a decision system 114, a message server 116 associated with a message system 118, and an external server 120 associated with an external system 122 that can communicate with other components of FIG. 1 through the network 102.

The network 102 may include one or more networks (for example, public network or virtual private network “VPN”). In a non-limiting example, the network 102 may include one or more local area networks (LANs), wide area networks (WANs), or any other communication network or method. Each of the components in FIG. 1 may communicate directly or indirectly with other components through the network 102.

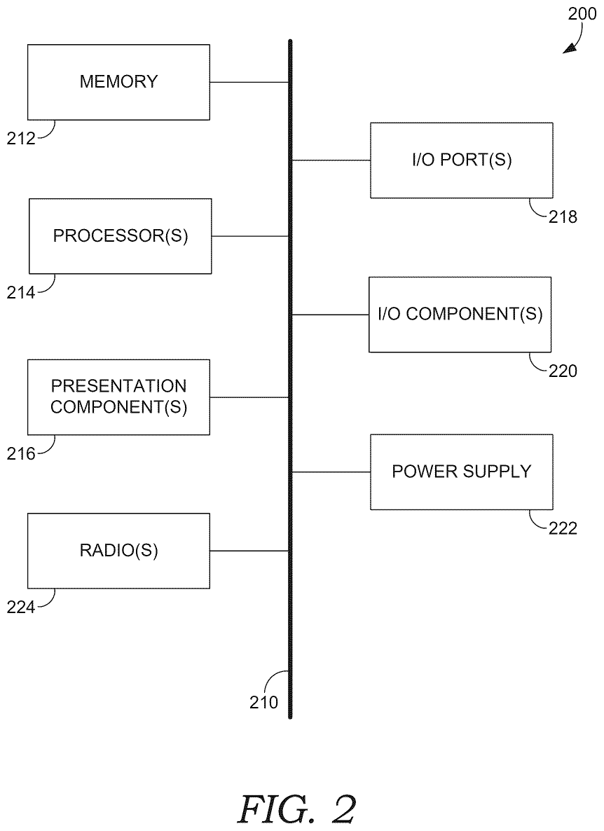

The operating environment 100 further comprises a data store 124. The data store 124 generally stores information including data, computer instructions (for example, software program instructions, routines, or services), or models used in the embodiments of the present disclosure. Although depicted as a single data store component, the data store 124 is embodied as one or more data stores or is in the cloud or other distributed architectures. One example suitable for use as the data store 124 is memory 212, discussed with reference to FIG. 2.

The data store 124 may include one or more storage devices configured to collect, store, delete, update, and/or modify data in accordance with one or more instructions received from one or more other components, the user server 104, the integration server 108, the decision server 112, the message server 116, and the external server 120. For example, the data store 124 may include any suitable combination of one or more storage mediums, such as hard disk drives, solid-state memory, cloud-based storage devices, etc. In various aspects, the data store 124 may store data in addition to or instead of data stored locally by the user server 104, the integration server 108, the decision server 112, the message server 116, and the external server 120. In doing so, the user server 104, the integration server 108, the decision server 112, the message server 116, the external server 120, the data store 124, and/or other backend components may store any suitable type of data used to facilitate various functionalities of certain aspects, as described herein.

Having identified various components of the operating environment 100, it is emphasized that any additional or fewer components, in any arrangement, may be employed to achieve the desired functionality and are within the scope of the present disclosure. Although the various components of FIG. 1 are shown with lines for the sake of clarity, the lines can illustrate a direct path of communication from one component to another or may represent a path where other intermediary components are present.

While the components of FIG. 1 are depicted as single components, the depictions are intended as examples in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether. As non-limiting examples, while the user server 104, the integration server 108, the decision server 112, the message server 116, and the external server 120 are each illustrated as a single server, it will be understood that each illustrates one or more servers working with one another in any arrangement. As another example, the data store 124 may illustrate one or more data stores provided in any arrangement throughout the operating environment 100. This may include one or more data stores 124 specifically associated with, and in communication with, each of the user servers 104, the integration server 108, the decision server 112, the message server 116, and the external server 120 to provide data and computer-usable instructions to each of their respective components. Therefore, for the sake of brevity and clarity, when the components of FIG. 1, or any other figure, are referred to in the singular, it is intended to include functions performed by one or more components working together.

The functionality of the operating environment 100 can be further described based on the functionality of the described components. That is, many of the components described in relation to FIG. 1 are entities that perform functions. Various functions described herein are being performed by one or more components and may be carried out by a hardware, a firmware, and/or a software. That is, functions performed by the components of FIG. 1 can be performed by executing computer-executable instructions stored in memory, such as the data store 124.

In general, a server, such as the user server 104, the integration server 108, the decision server 112, the message server 116, and the external server 120, comprises a processor in communication with computer-readable media. The processor executes instructions on the computer-readable media. As previously discussed, the servers illustrated as single servers can be one or more servers working to execute a particular described function.

In one aspect, the user server 104, the integration server 108, the decision server 112, the message server 116, and the external server 120 may be implemented as any suitable number and/or type of a computing device (for example, one or more computer servers) configured to communicate with other components, or one or more client interfaces, such as the user interface 106 (or suitable data stores and/or storage devices associated therewith), etc. In various aspects, the servers described above may be configured to process application programming interface (API) service calls, to support one or more applications installed on one or more devices associated with the user server 104, the integration server 108, the decision server 112, the message server 116, and the external server 120, etc.

As illustrated, the operating environment 100 comprises the user server 104 that is associated with the user interface 106 that can be any such user interface that allows the user or merchant to access accounts and pages associated with a merchant credit authorization. The user interface 106 can receive communications via the network 102 and the user server 104 and maintain accounts within the user server 104 in accordance with instructions received within the communications. For instance, the user interface 106 can identify a user's selection and input. The user interface 106 can cause to be displayed messages provided by the message system 118 and any other system that may communicate with the user interface 106 by way of the network 102. The user server 104 may also communicate instructions received from the user interface 106 by way of the network 102 to other servers, such as the integration server 108. The user interface 106 and the user server 104 are associated with the merchant applicant, an external bank, an external data store system, or any other user that may input or provide information to the network 102.

It will be understood that the integration server 108 may perform actions similar to the user server 104 on behalf of the integration system 110. Throughout the present disclosure, the integration server 108, the integration system 110 or integration service, the decision server 112, the decision system 114, the message server 116, the message system 118, the external server 120, and the external system 122 are referred to in terms of particular roles performed within the described example. However, it will also be understood that such servers and systems may perform other roles for different interactions.

It will be understood that the integration server 108 is associated with the integration system 110. The integration system 110 operates in part as a logic system that processes application data from the applicant by way of the user interface 106. The integration server 108 and the integration system 110 may operate in connection with the external system 122, the data store 124, and other systems to query various data stores, request information, or provide information to other systems and servers.

The decision server 112 on behalf of the decision system 114 may perform various activities. For instance, the decision server 112 can receive various datasets from one or more servers by way of the network 102. The decision server 112 operates using a variety of data logic systems including, but not limited to, simple rules-based logic, machine learning algorithms applied to a neural network, decision logic trees, or any other algorithm built and/or trained to make a variety of decisions based on the data provided.

In the present aspects, the decision server 112 is configured to access data from and/or store data to one or more additional data sources stored in the data store 124 that is included as one or more of backend computing devices. Additionally, or alternatively, the decision server 112 may access data from one or more servers, such as the user server 104, the integration server 108, the message server 116, and the external server 120, and/or data provided by one or more users associated with one or more user interfaces 106. In various aspects, any combination and/or subset of the aforementioned data may form a dynamic data set that changes over time as additional data is collected, and that is stored and/or updated in one or more components, such as the user server 104, the integration server 108, the decision server 112, the message server 116, and the external server 120, and transmitted by way of the network 102 and/or accessed by the decision server 112. For example, the decision server 112 may use any suitable portion of the dynamic data set as training data to train a machine learning model.

Once the machine learning model is trained in this way, the machine learning model is applied to data received to identify, predict, or decide various portions related to the process of approving or denying merchant credit application. Moreover, once such decisions, predictions, or identifications are made, aspects include the decision server 112 to receive results from a prior credit application so as to retrain or add additional training data to improve the machine learning model. The machine learning model is described here with respect to the decision server 112 and the decision system 114, but may be used with respect to any server and system described herein. For example, the integration server 108 may implement the machine learning model with respect to data retrieved by the server.

As illustrated, the operating environment 100 comprises the integration server 108 that is associated with the integration system 110. The integration server 108 can receive communications via the network 102 and maintain accounts within the integration server 108 in accordance with instructions received within the communications. For instance, the integration system 110 or the integration service may receive various portions of a merchant credit application and combine the portions into one application to be sent to the decision server 112 and the decision system 114 by way of the network 102. Additionally, the operating environment 100 comprises the message server 116, the message system 118, the external server 120, and the external system 122. Each of these systems and servers may operate in accordance with instructions received and may communicate with other servers and systems by way of the network 102. Each of the servers and systems may also retrieve information from the data store 124.

An example operating environment in which some of the present disclosure is implemented is described below in order to provide a general context for various aspects. Referring to FIG. 2, in particular, an example operating environment for implementing embodiments of the present disclosure is shown and designated generally as a computing device 200. The computing device 200 is an example of a suitable computing environment and is not intended to suggest any limitation as to the scope of use or functionality of the technology, and nor should the computing device 200 be interpreted as having any dependency or requirement relating to any one or combination of components illustrated.

The technology of the present disclosure is described in the general context of computer code or machine-useable instructions, including computer-executable instructions, such as program modules, being executed by a computer or other machine, such as a personal data assistant or other handheld device. Generally, the program modules including routines, programs, objects, components, data structures, etc., refer to a code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 2, the computing device 200 includes a bus 210 that directly or indirectly couples the following devices: the memory 212, one or more processor(s) 214, one or more presentation component(s) 216, input/output port(s) 218, input/output components 220, and illustrative power supply 222. The bus 210 represents what may be one or more buses (such as an address bus, data bus, or a combination thereof).

Although the various blocks of FIG. 2 are shown with lines for the sake of clarity, in reality, delineating various components is not so clear, and metaphorically, the lines would more accurately be grey and fuzzy. For example, one may consider a presentation component, such as a display device, to be an I/O component 220. As another example, processor(s) 214 may also have memory. Such is the nature of the art, and it is again reiterated that the diagram of FIG. 2 merely illustrates an example computing device that can be used in connection with one or more embodiments of the present disclosure. Distinction is not made between such categories as “workstation,” “server,” “laptop,” “handheld device,” etc., as all are contemplated within the scope of FIG. 2 and make reference to the “computing device.”

The computing device 200 typically includes a variety of computer-readable media. The computer-readable media can be any available media that can be accessed by the computing device 200 and includes both volatile and non-volatile media, and removable and non-removable media. By way of non-limiting example, the computer-readable media may comprise computer storage media and communication media.

The computer storage media includes volatile and non-volatile media, removable and non-removable media implemented in any method or technology for storage of information, such as computer-readable instructions, data structures, program modules, or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium that can be used to store the desired information that can be accessed by the computing device 200. The computer storage media excludes signals per se.

The communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information associated therewith. By way of non-limiting example, the communication media includes wired media, such as a wired network or direct-wired connection, and wireless media, such as acoustic, RF, infrared, and other wireless media. Combinations of any of the above should also be included within the scope of computer-readable media.

The memory 212 includes computer storage media in the form of volatile or non-volatile memory. The memory 212 may be removable, non-removable, or a combination thereof. Example hardware devices include solid-state memory, hard drives, optical-disc drives, etc. The computing device 200 includes one or more processor(s) 214 that read data from various entities, such as the memory 212 or the I/O components 220. The presentation component(s) 216 present data indications to a user or other device. Examples of the presentation component(s) 216 include a display device, speaker, printing component, vibrating component, etc.

The I/O port(s) 218 allow the computing device 200 to be logically coupled to other devices, including the I/O components 220, some of which may be built in. Illustrative components include a microphone, joystick, game pad, satellite dish, scanner, printer, wireless device, and the like.

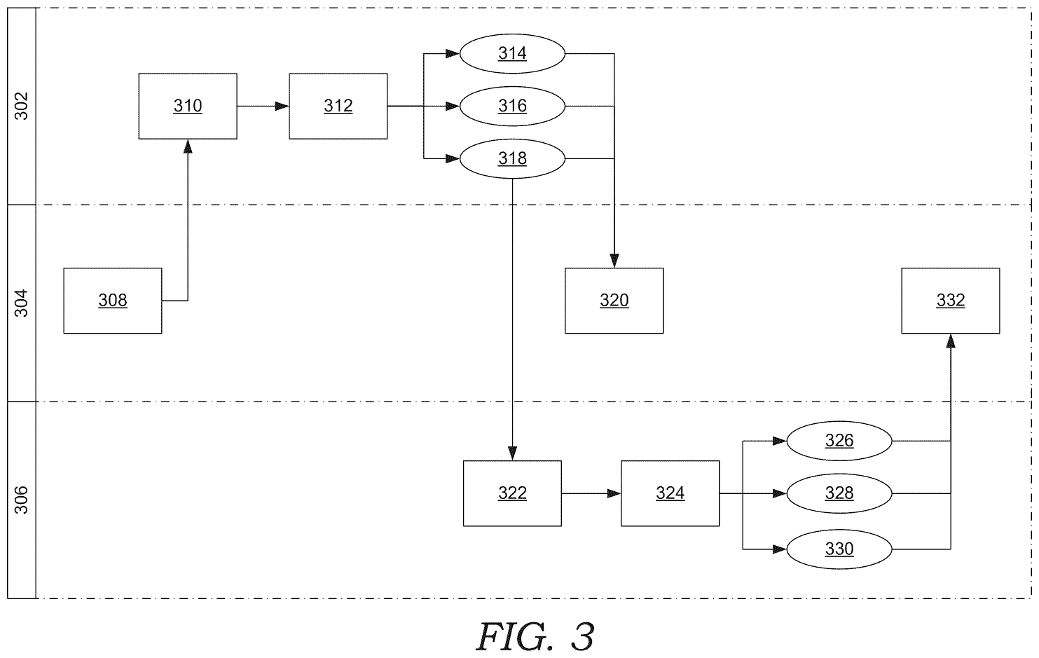

Turning now to FIG. 3, FIG. 3 represents an example process flow 300 that can be performed by components of the operating environment of FIG. 1 and the computing device 200 of FIG. 2, in accordance with an aspect described herein. The process flow 300 comprises three general services. The process flow 300 comprises a credit issuer service 302, an application service 304, and a merchant service 306. Each of the services corresponds to one or more servers and systems previously described herein. It is noted that the procedures are examples, and that other arrangements may be possible. All of these aspects, including various other arrangements, will be apparent to those of ordinary skill in the art in view of the present disclosure, and such aspects are contemplated within the scope of the present disclosure. While the process flow 300 is described as a series of steps, it should be recognized that these steps are illustrative and not intended to limit the present disclosure to the specific aspect illustrated in FIG. 3.

Application service 304 refers to a technological solution that enables users to apply for various services or programs through a digital platform. This service leverages the processors and digital interfaces to streamline and simplify the application process, making it more accessible, efficient, and user-friendly. Furthermore, the application service may employ advanced technologies such as data validation, automated checks, and real-time feedback to ensure the accuracy and completeness of the application. This helps users identify and correct errors or omissions, reducing the chances of application rejections or delays.

The application service 304 may provide an exemplary interface that allows the applicant, the merchant, or the credit issuer to start the merchant credit application by entering data into the user interface. In one example, the application service 304 may be a web-based application that uses the user to provide user authentication or identification to access the merchant credit application. The application service 304 may also provide selectable and fillable form fields that may detail what is required by the user or the merchant applicant for a complete merchant credit application. A user inputs applicant information into the user interface. In one aspect, the merchant info is saved or input into the application service 304 that may be associated with a database or data store, such as the data store 124 in FIG. 1.

In the back end of the application service 304, various technologies work together to handle the processing and management of applications. These technologies include: Database Management Systems (DBMS), such as MySQL, Oracle, or MongoDB, to store and manage application data. The DBMS ensures secure and efficient storage, retrieval, and organization of application information. Application service 304 may employ server-side programming languages like Python, Java, or PHP to handle application logic and data processing. These languages enable the implementation of business rules, data validation, and integration with other systems or APIs. Backend frameworks like Django, Ruby on Rails, or Node.js provide a structured environment for developing and deploying application services. They offer prebuilt modules, libraries, and tools that simplify the development process and enhance efficiency. Application service 304 systems integrate with external APIs to gather additional information or perform verification processes during the application review. APIs allow seamless communication with external services such as credit bureaus, identity verification services, or document validation services. Application service 304 may also incorporate authentication mechanisms, such as OAuth or JSON Web Tokens (JWT), to ensure secure access to the application service. They implement encryption protocols (e.g., SSL/TLS) to protect data transmission and employ security measures to prevent unauthorized access or data breaches.

In some examples, the application service 304 communicates with external services through various mechanisms such as web APIs, protocols, and data formats. The application service 304 API can use Representational State Transfer (REST) principles to communicate with external services. RESTful APIs use HTTP methods like GET, POST, PUT, and DELETE to perform operations on remote resources. The API sends requests to the external service's endpoints, receives responses in JSON or XML format, and processes the data accordingly. A SOAP (Simple Object Access Protocol) may be used for exchanging structured information over web services. The Application Service API can send SOAP requests to external services using XML-based messages. SOAP APIs often use Web Services Description Language (WSDL) files to define the operations and data structures.

In other examples, the application service 304 uses a GraphQL query language and runtime for APIs. This allows the application service 304 to request specific data and shape the response, such as external retrieval 310. The Application Service API can use GraphQL to send queries or mutations to external services, specifying the data fields and relationships. GraphQL APIs often respond with JSON payloads containing the requested data. The application service 304 can communicate with external services through message queues such as RabbitMQ or Apache Kafka. Application service 304 can publish messages containing relevant information or requests to the queue, and external services subscribed to the queue can consume those messages, process them, and provide responses.

In some cases, the application service 304 may communicate with external services, or any other services described herein, by exchanging files. This can involve uploading files to external services via FTP or SFTP, or retrieving files through secure protocols like HTTP. Further, to communicate with external services, or any other service described herein, the application service 304 may need to authenticate itself and obtain authorization. This can involve using API keys, OAuth tokens, or other authentication mechanisms provided by the services.

In some embodiments, the application service 304 may communicate with external servers to obtain information. In other embodiments, the credit issuer service 302 may communicate with external servers and systems in like manners, as described in relation to the application service 304. For example, the credit issuer service 302 may request that the application service 304 provide some manner of authentication mechanism, such as an API key.

In some embodiments, a hardware security module (HSM) can be incorporated into the architecture of the application service 304, credit issuer service 302, or merchant service 306 to enhance the security of sensitive data and cryptographic operations. In one example, an HSM can be used to securely generate, store, and manage cryptographic keys used by the application service 304 or any other service provided herein. The HSM protects the keys from unauthorized access and provides secure key storage capabilities, ensuring the confidentiality and integrity of the keys. The HSM can offload and perform cryptographic operations, such as encryption, decryption, digital signing, and verification. Instead of performing these operations in the application service's software layer, the sensitive cryptographic operations are securely executed within the tamper-resistant environment of the HSM. This helps to protect against attacks and ensures the integrity of cryptographic processes.

The HSM can provide secure storage for sensitive data, such as encryption keys, passwords, or credentials. By utilizing the HSM's secure storage capabilities, the application service 304, the credit issuer service 302, and the merchant service 306 can store sensitive data in an encrypted form within the HSM, reducing the risk of data exposure or unauthorized access. HSMs are designed with physical security measures to protect against tampering, including tamper-resistant casings, intrusion detection mechanisms, and self-destruct capabilities. By incorporating an HSM, the application service 304, the credit issuer service 302, and merchant service 306 benefit from the robust physical security of the hardware, mitigating risks associated with physical attacks on the system. The HSM can enforce strict access controls and authentication mechanisms to ensure that only authorized entities can utilize the cryptographic keys and perform operations within the HSM. This strengthens the security of the application service by preventing unauthorized access to sensitive cryptographic operations and key material.

In some embodiments, HSMs often provide built-in logging and auditing capabilities, allowing for comprehensive tracking of cryptographic operations and key management activities. This supports compliance requirements and enables monitoring, review, and analysis of security-related events. When incorporating an HSM, the application service 304, the credit issuer service 302, and merchant service typically interact with the HSM via a standardized interface or API, which allows secure communication and control over the HSM's functionality. The HSM may be physically integrated into the infrastructure hosting the application service or accessed remotely as a dedicated hardware device or a cloud-based HSM service.

The credit issuer service 302 represents a technological solution provided by financial institutions, merchant credit companies, or business-to-business credit companies to manage and facilitate the issuance of credit to consumers or businesses. This service leverages technology to assess creditworthiness, generate risk metrics, monitor transactions, and streamline credit-related processes. Through the credit issuer service 302, financial institutions can utilize sophisticated algorithms and machine learning models to evaluate applicants' credit profiles and determine their creditworthiness. These technologies analyze various factors such as credit history, income, debt levels, and payment patterns to make data-driven decisions regarding credit approval and credit limits. Moreover, the credit issuer service incorporates advanced fraud detection mechanisms to identify and prevent fraudulent transactions. It can leverage real-time transaction monitoring, anomaly detection, and pattern recognition to swiftly detect suspicious activities and mitigate potential risks. Additionally, the credit issuer service 302 provides merchant users with digital access to their credit information, account management tools, and secure payment options. This empowers businesses to conveniently track their credit usage, make payments, and manage their credit accounts using online portals or mobile applications.

In some embodiments, the credit issuer service 302 may use advanced machine learning algorithms to analyze credit-related data and generate risk metric scores. These algorithms consider factors like credit history, income, debt-to-income ratio, business age, business with consumer information, business without consumer information, and payment behavior to determine creditworthiness. The credit issuer service 302 may also utilize decision engines that apply predefined rules and algorithms to evaluate credit applications, as described in more detail below. In some aspects, there can be deterministic logic as well e.g. automatically reject all businesses with a bankruptcy in the last 7 years irrespective of what the machine learning credit risk may indicate. These engines process the credit scores and other relevant data to make automated decisions regarding credit approval, credit limits, and interest rates. The credit issuer service 302 may employ data analytics tools and techniques to gain insights from credit-related data. These technologies enable the identification of patterns, trends, and risk factors, facilitating more informed decision-making.

In other embodiments, the credit issuer service 302 may integrate with fraud detection systems that employ machine learning algorithms and anomaly detection techniques to identify and prevent fraudulent activities. These systems analyze transaction data in real-time, flagging suspicious patterns or behaviors for further investigation. The credit issuer service 302 can establish integrations with credit bureaus to access credit reports and obtain up-to-date credit information of applicants. This integration allows for accurate assessment of creditworthiness based on comprehensive credit data.

The merchant service 306 is a technological solution that leverages a risk metric generated by the credit issuer service 302 to make credit decisions. It allows merchants to independently approve or deny a user's credit application, even after the credit issuer has initially denied it. In this scenario, the merchant service 306 assumes the credit risk associated with the user's application. The merchant service 306 operates as a platform or system that facilitates credit evaluation and decision-making for merchants. It integrates with the credit issuer service 302 to receive a risk metric that has been generated based on the user's credit application.

When a user submits a credit application, the credit issuer service 302 processes the application data and generates a risk metric that reflects the user's creditworthiness. This risk metric is then securely transmitted to the merchant service 306. Upon receiving the risk metric, the merchant service 306 utilizes it as a key input for its credit decision process. The merchant can independently review the risk metric, along with other relevant information, such as the user's application details and supporting documentation. Based on the risk metric and any additional criteria specified by the merchant, the merchant service 306 enables the merchant to make an informed credit decision.

The merchant, using merchant service 306, can assess the risk associated with the user's credit application and decide whether to approve, deny, or partially approve it, considering their own risk tolerance and business considerations. If the merchant chooses to approve the user's credit application, they assume the credit risk associated with providing the requested credit or extending the user's credit limit. Through the integration of the credit issuer service 302 risk metric, the merchant service 306 empowers merchants to make credit decisions based on a comprehensive assessment of the user's creditworthiness. This integration allows merchants to consider additional factors beyond the credit issuer's initial decision, providing them with more flexibility and the ability to offer credit opportunities to users who may have been denied by traditional credit issuers. The merchant service 306 ensures secure communication and data protection measures to safeguard the risk metric and sensitive user information. It may also provide reporting and monitoring functionalities to assist merchants in tracking credit performance and managing credit risk effectively.

In some embodiments, the merchant service 306 integrates with the credit issuer service 302 through APIs or data connectors to receive the risk metric generated by the credit issuer service. This integration ensures seamless data flow between the services, enabling the merchant service 306 to access the risk metric for credit evaluation. The merchant service 306 includes components for securely processing and storing data related to credit applications and risk metrics. This involves utilizing DBMS such as MySQL or PostgreSQL to store and retrieve relevant information, ensuring efficient data organization and retrieval. The merchant service 306 may employ algorithms and machine learning to analyze the risk metric received from the credit issuer service 302. These algorithms assess the risk metric along with other criteria specified by the merchant to determine the creditworthiness of the user's application. This analysis may involve comparing the risk metric against predefined thresholds or rules to make an informed credit decision. The merchant service 306 may also incorporate a credit decision engine that applies the defined credit evaluation rules and algorithms. The credit decision engine evaluates the risk metric, user application details, and any additional merchant-specific criteria to generate a credit decision, such as approval or denial of the credit application. Merchant service 306 may also enforce secure authentication mechanisms and access controls to ensure that only authorized personnel can access and perform credit evaluations within the Merchant Service. This helps protect sensitive user data and ensures the integrity of the credit decision-making process.

Merchant service 306 employs secure communication protocols (e.g., HTTPS) and data encryption techniques to protect the transmission and storage of sensitive data, including the risk metric received from the credit issuer service. Encryption mechanisms safeguard the integrity and confidentiality of the data, mitigating the risk of unauthorized access or data breaches. Additionally, the merchant service 306 incorporates logging and auditing functionalities to record credit decision-making processes, user interactions, and system activities. This enables monitoring, review, and analysis of credit decisions, providing an audit trail for compliance purposes and troubleshooting potential issues.

Within the application service 304, an applicant such as a user or a business entity desiring to be issued credit through the credit issuer to be used with the merchant associated with the merchant service 306 provides a credit application through the application service 304 at step 308. This can be done via an online form, an application portal, or an API request. The application typically includes personal or business details, financial information, employment history, references, and any other relevant data needed for the credit evaluation process. The application service 304, as part of the applicant process, collects the credit application data provided by the applicant. This involves securely capturing the information and ensuring its integrity during transmission. The service may employ encryption and other security measures to safeguard the sensitive data.

Additionally, at the application entry step 308, the application service 304 may perform validation and verification checks on the provided data. This step ensures that all mandatory fields are completed, and the data is formatted correctly. The service may conduct basic verification checks, such as confirming the accuracy of contact information or validating certain identification details. If the credit application requests supporting documentation, the application service 304 provides a mechanism for the applicant to upload the necessary files. This could include documents such as identification cards, financial statements, tax records, or any other documents relevant to the credit evaluation process.

The application service 304 at the application entry step 308 processes the credit application data to prepare it for further evaluation. This may involve data transformation, normalization, or cleansing to ensure consistency and accuracy. The service may also extract key information from uploaded documents using OCR (Optical Character Recognition) or other document processing techniques. The processed credit application data is securely stored within the application service 304 backend systems. This typically involves using a DBMS or secure storage infrastructure to ensure the confidentiality, integrity, and availability of the data. After processing the credit application data, the application service 304 communicates with the credit issuer service 302 to provide the necessary information for the credit evaluation process. This may involve transmitting the credit application data, relevant documents, and any additional metadata required for a comprehensive assessment. This communication may be done in accordance with steps described above in relation to the two services communicating.

Once the credit issuer service 302 receives the credit application and the information and documents associated with it, the credit issuer service 302 processes the data and retrieves external credit information at external retrieval 310 associated with the applicant. The credit issuer service 302 may query an external database related to the business entity or applicant. The query by the credit issuer service 302 to the external sources is based at least in part on the merchant-entered info in the application process step 308. The credit issuer service 302 may directly communicate with the credit insurer by way of an API.

The external retrieval 310 may retrieve credit reports and scores from credit bureaus and reporting agencies. These reports provide information about the business's credit history, payment patterns, outstanding debts, and public records such as bankruptcies or liens. Credit reports help assess the business applicant's creditworthiness and evaluate its ability to meet financial obligations. The application service 304 can access business credit reports that provide specific details about the business's credit performance, payment history, and credit utilization. These reports may include information from credit bureaus specialized in business credit reporting, such as Dun & Bradstreet or Experian Business. The external retrieval 310 may search public records databases to retrieve information on legal filings, liens, judgments, or bankruptcies associated with the business. These records help assess the business's legal and financial standing, identify potential risks, and evaluate its overall stability. In further embodiments, the external retrieval 310 may access databases or platforms maintained by regulatory bodies or licensing authorities to verify the business's compliance with industry-specific regulations, licenses, or permits. This information helps assess the business's legal status, adherence to industry requirements, and potential risks associated with non-compliance. Business details also may contain information related to the duration that the business has been established. The external retrieval 310 may contact trade references provided by the business applicant to gather information about the business's payment history and trade relationships. These references may include suppliers, vendors, or other businesses with whom the applicant has conducted transactions. Insights from trade references contribute to evaluating the business's reliability and creditworthiness.

The external retrieval 310 may retrieve industry-specific data or market research reports relevant to the business applicant's sector. This information may be insights into market trends, competitive landscape, and the overall health of the industry. The external retrieval may leverage web scraping techniques or APIs to retrieve information from public websites, business directories, or social media platforms. This can include gathering details about the business's online presence, customer reviews, social media activity, or news articles. Online data sources offer additional context and insights into the business's reputation and public perception. Additionally, the external retrieval 310 may collaborate with financial institutions or banks to access information about the business's banking history, existing loans, or credit relationships. This data contributes to evaluating the business's financial stability, cash flow management, and creditworthiness.

In some instances, the business entities within the external retrieval 310 are stored in a non-standardized form. For example, the external database can store business information in an array, linked list, stack, queue, hash table, tree, heap, graph, or any other data form. The credit issuer service 302 may retrieve business information from multiple database sources, each having a different non-standardized form. Additionally, the external databases accessed can also change a form of storage of the data. By using the volatility-based decomposition architecture, the external data may be modified to be able to convert new types or forms of data structure to a data form used by the credit issuer service 302.

Once the non-standardized data is retrieved from the external database, the credit issuer service 302 converts the non-standardized external data and applicant data into a risk metric. The risk assessor 312 involves analyzing the gathered information and assigning a numerical value or score that represents the level of risk associated with extending credit to the applicant. The risk assessor 312 may identify the key risk factors that will be considered in the risk assessment process. These factors may include credit history, financial stability, industry risk, payment patterns, legal or regulatory compliance, and any other relevant aspects specific to the credit evaluation criteria. The risk assessor 312 may assign relative weights to each risk factor based on their importance in the credit evaluation process. The weights reflect the significance of each factor in determining the overall risk level. For example, credit history might be given a higher weight than industry risk if it is considered a critical factor. Next, the risk assessor may define a scoring mechanism for each risk factor. This involves establishing a scale or range that quantifies the level of risk associated with each factor. For instance, credit history might be scored on a scale of 1 to 5, with 1 representing excellent credit and 5 indicating poor credit.

In additional embodiments, the risk assessor 312 may evaluate each risk factor based on the data collected from both internal and external sources and assign the appropriate score to each factor based on the applicant's specific information. This evaluation can be performed through algorithms or decision models. Subsequently, the scores of each risk factor are multiplied by their respective weights to reflect their relative importance. This step allows for an overall assessment of the applicant's risk level, considering the different factors and their significance.

In some embodiments, the risk assessor 312 parses or extracts features of historical data, learns (e.g., via machine learning model training) about the historical data by making observations or identifying patterns in data, and then receive a subsequent input (a current data point) in order to make a determination, prediction, and/or classification of the subsequent input based on the learning. This learning information can then be consolidated based on the data learned. In some embodiments, the risk assessor 312 is or includes one or more machine learning models, such as neural networks, random forest models, logistic regression, linear regression, k-nearest neighbor, Bayesian networks, and the like. For example, the risk assessor 312 may identify a pattern in the historical data associated with historical applicants that indicate a likelihood of default on borrowed credit or in other words, a custom risk assessment. In some embodiments, the risk assessor 312 uses a “genetic algorithm,” which generates group consolidation candidates, where each mutation or iteration has a fitness level associated therewith.

As described above, in some embodiments the risk assessor 312 can represent or use one or more machine learning models that train on data to make predictions and generate a risk metric. Training is the process of machine learning model learning or tuning such that a prediction statistic (e.g., a classification prediction, a regression prediction, or clustering prediction) may become more increasingly accurate with higher confidence (and ideally with a lower error rate) after a particular threshold quantity of training sessions or epochs. For example, using the illustration above, the risk assessor 312 may identify a pattern, over various training stages, in historical applicant data. The historical applicant data comprises a set of training data that represents prior applicants that were either approved, denied, or partially approved. The confidence level for this prediction may get higher after each training stage and/or the actual chance of inspection may change.

In some embodiments, training may include learning features (or feature values) of feature vectors (real numbers representing data) and responsively weighting them during training. A “weight” in various instances corresponds to the importance or significant of a feature or feature value for a decision statistic. For example, each feature may be associated with an integer or other real number where the higher the real number, the more significant the feature is for its classification. In some embodiments, a weight in a neural network or other machine learning application can represent the strength of a connection between nodes or neurons from one layer (an input) to the next layer (an output). A weight of 0 may mean that the input will not change the output, whereas a weight higher than 0 changes the output. The higher the value of the input or the closer the value is to 1, the more the output will change or increase. Likewise, there can be negative weights. Negative weights proportionately reduce the value of the output. For instance, the more the value of the input increases, the more the value of the output decreases. Negative weights may contribute to negative scores, which are described in more detail below.

The risk assessor 312 parses or extracts features of historical data, learns (e.g., via machine learning model training) about the historical data by making observations or identifying patterns in data, and then receives a subsequent input (a current data point) in order to make a determination, prediction, and/or classification of the subsequent input based on the learning. This learning information can then be consolidated based on the data learned. In some embodiments, the risk assessor 312 is or includes one or more machine learning models, such as neural networks, random forest models, logistic regression, linear regression, k-nearest neighbor, Bayesian networks, and the like. For example, the risk assessor 312 may identify a pattern in the historical data associated with historical applicants that indicate a likelihood of default on credit or a custom risk assessment. In some embodiments, the risk assessor 312 uses a “genetic algorithm,” which generates group consolidation candidates, where each mutation or iteration has a fitness level associated therewith.

As described above, in some embodiments the risk assessor 312 represents or uses one or more machine learning models that train on data to make predictions. Training is the process of machine learning model learning or tuning such that a prediction statistic (e.g., a classification prediction, a regression prediction, or clustering prediction) may become increasingly accurate with higher confidence (and ideally with a lower error rate) after a particular threshold quantity of training sessions or epochs. For example, using the illustration above, the risk assessor 312 may identify a pattern, over various training stages, in the historical applicant data. The confidence level for this prediction may get higher after each training stage and/or the actual chance of inspection may change.

In some embodiments, training may include learning features (or feature values) of feature vectors (real numbers representing data) and responsively weighting them during training. A “weight” in various instances corresponds to the importance or significance of a feature or feature value for a decision statistic. For example, each feature may be associated with an integer or other real number where the higher the real number, the more significant the feature is for its classification. In some embodiments, a weight in a neural network or other machine learning application can represent the strength of a connection between nodes or neurons from one layer (an input) to the next layer (an output). A weight of 0 may mean that the input will not change the output, whereas a weight higher than 0 changes the output. The higher the value of the input or the closer the value is to 1, the more the output will change or increase. Likewise, there can be negative weights. Negative weights proportionately reduce the value of the output. For instance, the more the value of the input increases, the more the value of the output decreases.

In some embodiments various feature vectors can represent individual applicant profiles and corresponding risk categories, according to some embodiments. A “feature vector” (also referred to as a “vector”) as described herein includes one or more real numbers, such as a series of floating values or integers that represent one or more other real numbers, a natural language (e.g., English) word and/or other character sequence or data sets.

A plurality of feature vectors that are embedded based on distance (e.g., Euclidian distance) represent “feature space.” The distance between any two feature vectors or class/cluster of vectors is measured according to any suitable method. For example, in some embodiments, automated cosine (or Euclidean) distance similarity is used to compute distance. Cosine similarity is a measure of similarity between two non-zero feature vectors of an inner product space that measures the cosine of the angle between the two non-zero feature vectors. In these embodiments, no similarity is expressed as a 90-degree angle, while total similarity (i.e., the same word) of 1 is a 0-degree angle.

Some embodiments generate or derive a feature vector that computers are configured to analyze. For example, the representation of an applicant's credit history or other relevant data might be converted into a first feature vector via vector encoding. This vector representation may correspond to ordered data points, indicating the presence or absence of certain risk factors. Each character sequence (e.g., a data point) in an applicant's history might be one-hot encoded, aggregating multiple risk factors into a single token represented as a one-hot vector with one ‘1’ element and all remaining elements ‘0s’.

In some embodiments, the risk assessor 312 aggregates each feature value of a vector based on performing a linear function or otherwise combining the output (e.g., a dot product or a softmax function) where the output is a feature vector or vector space embedding. The feature vector may thus be indicative of the actual coordinates that a feature vector will be embedded in feature space. For example, using the illustration above, the encoded feature vector might be converted or encoded to an output layer vector, which represents the 2-dimensional plotting coordinates in feature space.

In some embodiments, the feature space represents the functionality used by the risk assessor 312 to determine the class or cluster of risk that a given applicant's data point belongs to. For example, if a first vector represents data point-1, then the classification that is nearest to the data point-1 is determined to be the “high risk of default” classification indicative of the applicant's profile having a high risk of defaulting. This approach enables the identification of individual patterns for features, allowing reliable predictions of risk associated with an applicant.

In an illustrative example of how the feature space is used, embodiments may receive a set of historical applicant profiles that are labeled as “defaulted” or “not defaulted.” Responsive to processing a labeled profile through one or more machine learning models, features (e.g., payment history, income level, etc.) for the profile are extracted and weighted, after which a feature vector (e.g., representing the data point-1) is embedded in the feature space. The feature space, in various embodiments, represents a multidimensional coordinate system where each feature is associated with one or more dimensions. Each of the data points within the class, for example, are within a feature similarity threshold and so they are close to each other (e.g., based on Euclidean distance) in the feature space. Responsive to the embedding of the feature vector in the feature space, embodiments classify or cluster the first set of entries. This methodology enables the reliable prediction of the risk of default for an applicant, potentially identifying high-risk applicants based on the patterns observed

In constructing a risk metric for an applicant, the risk assessor 312 uses the described machine learning techniques along with vector analysis to systematically analyze and predict applicant behavior based on historical data. The process begins by the extraction and parsing of key features from a dataset comprising historical applicant profiles, which have been labeled with outcomes such as “defaulted” or “not defaulted.” These extracted features are converted into numerical form, generating representative feature vectors.

The process involves the using machine learning algorithms, including but not limited to neural networks, random forest models, and logistic regression techniques. These algorithms are employed to process the feature vectors through a series of training epochs, where the model incrementally learns from the data. During this training phase, the model is tuned to recognize complex patterns and correlations between the features and the historical outcomes, optimizing the prediction accuracy through iterative adjustments of the model parameters, particularly the weights assigned to each feature. These weights signify the relative importance of each feature in the predictive model, dictating how strongly each feature influences the overall risk assessment.

Once the model is adequately trained, the risk assessor 312 applies this learned knowledge to new applicant data. Feature vectors generated from current applicant profiles are introduced into the model, which then projects these vectors into a predefined vector space that was established during training. This vector space is structured such that distances between vectors quantitatively reflect the degree of risk similarity; closer vectors indicate similar risk profiles based on the model's learned criteria.

The final risk metric is computed by analyzing the position of a new applicant's feature vector within this vector space, particularly in relation to clusters of historical vectors associated with known default outcomes. The proximity of the new vector to these clusters enables the model to assign a probabilistic risk score, effectively categorizing the applicant into a corresponding risk bracket.

Once the risk metric is generated, the credit issuer service 302 can then determine if they will issue credit to the applicant. The risk metric analysis can lead to three potential outcomes: approved 314, denied 316, or approve for less area 318. If the application falls within a predetermined acceptable risk threshold set by the credit issuer associated with the credit issuer service 302, the credit application is approved. This indicates that the applicant's creditworthiness meets the desired criteria, and they are considered low risk. The approval allows the applicant to access the requested credit or credit services.

If the risk metric exceeds the predetermined acceptable risk threshold, the credit application is denied 316. This implies that the applicant's creditworthiness does not meet the required standards or is considered too risky for credit extension. The denial indicates that the lending institution or credit issuer determines the applicant's creditworthiness as insufficient or potentially high risk, leading to the denial of the credit application.

In some cases, the risk metric may fall within a range that is neither clearly above nor clearly below the predetermined risk thresholds. This approve for less area 318 indicates a level of uncertainty or ambiguity in the credit decision. Further evaluation or additional information may be necessary to make a definitive determination. If the risk metric falls within the approve for less area, the credit issuer may allow the merchant to approve or deny the application while taking on the risk themselves. In this case, the merchant holds the risk and the credit issuer still processes the credit the same as if they had issued the credit under a normal approved 314 situation.

At step 320, once a credit application has been approved or denied, the applicant is notified of the decision at the application service 304. The application service 304 generates a notification or communication to inform the applicant about the decision on their credit application. The notification is typically sent through a preferred communication channel specified by the applicant, such as email, SMS, or an online portal. It provides clear and concise information about whether the application has been approved or denied.

If the credit application is approved 314, the application service proceeds with the normal processing of the credit for the approved applicant. This involves initiating the necessary steps to grant the requested credit or credit services to the applicant, based on the terms and conditions specified by the lending institution or credit issuer. The approved applicant may be requested to review and sign a credit agreement or other relevant documentation. This agreement outlines the terms, conditions, interest rates, repayment schedules, and any other contractual obligations associated with the approved credit. The applicant acknowledges their understanding and acceptance of the terms by signing the agreement. Once the credit agreement is signed, the credit issuer service 302 proceeds with the disbursement of the approved credit amount to the applicant. Following the credit approval and disbursement, the credit issuer service 302 may provide the applicant with access to an online account or portal where they can manage their credit account. This account management interface allows the approved applicant to view account balances, make payments, track transactions, and access relevant account information.

In an additional example, the credit service 302 can provide partial approval of the credit limit and the merchant service 306 can provide the remaining partial credit approval for the remaining requested credit limit. In this case, the risk metric for the applicant does not allow for the approval of the applicant for the desired credit amount, but does allow for the partial approval of the applicant. For example, if the applicant initially requests a credit limit of $10,000 but their risk metric allows only for the approval of $5,000. In this case, the credit issuer service can approve the partial credit limit and send the remaining unissued credit approval to the merchant service 306 for approval. In this example, the merchant service 306 can approve and take on the risk for the remaining credit limit. In this case, where the risk metric indicates that there is some ambiguity or falls within a predetermined range of a approve for less area, the application along with the risk metric may be sent to the merchant service 306 for further review at step 322. The application is sent but the entire external data is not sent; rather, the risk metric associated with the applicant is sent. This allows the merchant service 306 to review the application and make a determination as to whether or not merchant, along with the issuer, will take the risk and approve the applicant.

The merchant risk evaluator 324 may then take the application and analyze all of the information received at step 322. When the risk metric for an applicant falls within the approve for less area, indicating an uncertain level of risk or that a partial approval by the credit service 302, the merchant service 306 may initiate a more detailed evaluation of the credit application. This involves reviewing additional information, conducting further analysis, and considering supplementary factors to make an informed credit decision. The merchant service 306 may request the applicant to provide additional documentation or information that can help clarify any uncertainties or address specific concerns related to the credit application. This could include financial statements, business references, or any other relevant data that can assist in the evaluation process.

The merchant service 306 may establish a decision-making framework or guidelines specifically designed to handle approve for less area applications. This framework provides a structured approach to considering various factors, evaluating risk indicators, and weighing the potential benefits and risks associated with approving the application. This may include prior dealings with the applicant or other factors that may be weighted into the decision. The decision made by the merchant service 306 may be automated using a system where the risk metric is further categorized into “approve” or “deny” predetermined thresholds. Further, the merchant service 306 may determine that the merchant must make a further manual review and may then advise a manager that the applicant must be reviewed.

The merchant service 306 may then determine that the application is approved 328 or denied 326 or partially approved 330. If the merchant service 306 denies 326 the application, the applicant is notified at step 332 that the application has been approved for the amount approved by the credit service 302. This notification is typically sent through a preferred communication channel, such as email, SMS, or an online portal. These steps could involve an appeal process or the option to request a manual review of the credit application to increase the credit limit to the requested amount. By offering these options, the merchant service provides an avenue for applicants to address any potential errors or provide additional information that could influence the credit decision. If the applicant believes that the reduced credit limit was based on incorrect or incomplete information, they may choose to initiate an appeal. The appeal process typically involves submitting a formal request along with any supporting documentation or explanations that can help strengthen the creditworthiness argument. The merchant service 306 or the credit issuer service 302 then reviews the appeal and reevaluates the credit application based on the additional information provided.

If the merchant service 306 indicates that the application is approved 328, the applicant is then notified that the credit issuer will issue credit. However, in the case that the merchant service 306 has approved 328 the application, the merchant is assuming all credit risk, not the credit issuer. In this case the applicant is not notified that the risk is being taken by the merchant. Although the applicant is not explicitly informed that the credit risk is being assumed by the merchant rather than the credit issuer, it is an underlying understanding within the merchant service 306 process. The credit issuer's role may include facilitating the disbursement of the approved credit amount or providing support services, while the merchant assumes the risk associated with the approved credit. The credit issuer also assumes the role of payment collector and may collect due and past due payments.

Once approved by either the credit issuer or the merchant, the applicant is notified and credit is issued by the credit issuer service 302. The credit issuer service 302 prepares a credit agreement that outlines the terms, conditions, and obligations associated with the approved credit. This agreement includes details such as the approved credit limit, interest rates, repayment schedule, and any applicable fees or charges. The approved applicant is requested to review, sign, and return the credit agreement to indicate their acceptance of the terms. Upon receiving the signed credit agreement, the credit issuer service 302 sets up a credit account for the approved applicant. This involves assigning a unique account number, creating account records, and linking the account to the applicant's identification and contact details.

If the merchant service 306 indicates that the application is partially approved 330, the applicant is then notified that the credit issuer will issue credit. However, in the case that the merchant service 306 has partially approved 330 the application, the merchant is assuming a first portion of the credit risk and the credit issuer is assuming a second portion of the credit risk. The credit issuer has made an initial decision of how much credit they are willing to assume and the merchant has indicated an additional amount of credit that the merchant is assume. In this case, the applicant is not notified that any portion of the risk is being taken by the merchant. Although the applicant is not explicitly informed that the credit risk is being assumed by the merchant rather than the credit issuer, it is an underlying understanding within the merchant service 306 process. The credit issuer's role may include facilitating the disbursement of the approved credit amount or providing support services, while the merchant assumes the risk associated with the approved credit. The credit issuer also assumes the role of payment collector and may collect due and past due payments.

In an additional example, the applicant may have an initial credit amount issued by the credit issuer. For example, the applicant can have an initial credit limit where all the risk is assumed by the credit issuer. The applicant can then request an additional amount of credit. The credit issuer, in this example, can deny the additional request but the merchant subsequently can approve to take the risk for the additional credit amount. For example, if the applicant requests an additional line of credit beyond what is issued by the credit issuer, the merchant can assume the risk for the additional amount. As such, a first portion is assumed by the credit issuer and a second portion risk is assumed by the merchant.

In additional examples, the applicant request additional credit line increases, following an initial credit line approval. As each request is approved, denied, or partially approved, the amount of risk is apportioned accordingly to the credit issuer or the merchant. For example, the credit issuer can decide to approve an additional portion of credit and the merchant can decide to add an addition portion of credit. As such, the amount of credit increases, and the risk or the portion of risk attached to the credit issuer or the merchant changes based on the subsequent approval. For example, an initial approval by the credit issuer can be a 100% risk by the credit issuer for $100. A subsequent credit line can be approved by the merchant for an additional $100. In this case, the total credit line would be $200 with the merchant assuming 50% of the risk and the credit issuer assuming 50% of the risk. In an additional example, an additional credit line increase approved by the merchant of $200 would increase the credit line to $400 and the percentage of risk to 25% assumed by the credit issuer and 75% by the merchant.

Once approved by the credit issuer, the merchant, or both, the applicant is notified and credit is issued by the credit issuer service 302. The credit issuer service 302 prepares a credit agreement that outlines the terms, conditions, and obligations associated with the approved credit. This agreement includes details such as the approved credit limit, interest rates, repayment schedule, and any applicable fees or charges. The approved applicant is requested to review, sign, and return the credit agreement to indicate their acceptance of the terms. Upon receiving the signed credit agreement, the credit issuer service 302 sets up a credit account for the approved applicant. This involves assigning a unique account number, creating account records, and linking the account to the applicant's identification and contact details.

Depending on the type of credit, the credit issuer service 302 may disburse the approved credit amount to the approved applicant in one or multiple disbursements. For example, in the case of a charge card, the credit issuer may issue the physical card and activate the credit line associated with it. The credit issuer service 302 establishes a payment schedule that outlines the due dates, minimum payment amounts, and other relevant payment terms. The billing cycle is determined, specifying the period for which transactions and charges are accumulated before generating a billing statement. The credit issuer service 302 generates monthly statements that detail the transactions made on the credit account during the billing cycle. The statement provides a summary of the outstanding balance, available credit, transaction details, and any applicable fees or interest charges. It serves as a record of the credit activity and provides a clear overview of the payment obligations. The credit issuer service 302 sends payment reminders to the approved applicant before the payment due date. These reminders can be in the form of electronic notifications, emails, SMS messages, or physical letters, providing a reminder of the upcoming payment and the amount due.

The credit issuer service 302 collects payments from the approved applicant based on the established payment schedule. Payments can be made through various channels, including online payment portals, bank transfers, checks, or automatic deductions from a designated bank account. The credit issuer processes the received payments, updates the account balance, and reflects the payment status in the applicant's credit account. Throughout the credit period, the credit issuer service 302 monitors the approved applicant's account for any irregularities, non-payment, or potential credit risks. The credit issuer service 302 provides customer support services to address inquiries, clarify billing concerns, and assist with any account-related issues.

In cases where partial credit was issued by the credit issuer and partial credit was issued by the merchant, recourse when non-payment, delinquency, partial payment, or late payments is calculated based on credit risk assumed at the time of credit used. In one embodiment, f the merchant issues a first credit limit to the applicant and the applicant uses a portion of that credit, the credit issuer assumes the entire risk for that first portion of credit used, even if at a later time, the merchant assumes a risk for a credit line increase. For example, the applicant can use $100 of a $100 credit issued by the credit issuer and is subsequently issued a credit line increase by the merchant. If, in this example, the applicant defaults, the credit issuer assumes all of the bad debt, even though the credit line was increased and the merchant assumed the risk for that increase. This is because the credit used was prior to the assumption of risk by the merchant. As such, each purchase or invoice that uses the applicant credit line is stamped or assigned a recourse percentage. If a second purchase were made after the credit line increase was approved, a default on that purchase would be assumed by both the merchant and the credit issuer at the percentage of risk of the credit line at the time of purchase or invoicing.

To implement the outlined credit risk management strategy, several technical steps are followed. Initially, every instance of credit issuance-whether by the credit issuer or the merchant-is tracked with unique identifiers, amount, and issuance date to ensure clear accountability on the timing and responsibility. Upon each credit utilization by the applicant, a risk assessment is immediately conducted. This assessment determines the percentage of risk assumed by each party at that specific moment, considering the total credit limit used, the portions extended by each party, and any changes to the credit limit thereafter.

For each transaction, a specific recourse percentage is calculated and assigned, stamped onto the purchase invoice or credit transaction record. This percentage reflects the distribution of risk based on the credit limit at the time of the transaction, utilizing a formula that considers the proportional credit extended by each party up to the point of the transaction. In the event of a default, a systematic approach is employed to ascertain the financial liability of each party based on the transaction records and the risk assumed at the time of each credit use, distributing the default impact according to the established recourse percentages.

Furthermore, the system is designed for continuous monitoring and adjustment. It keeps an ongoing watch over all credit limits, adjustments, and transactions, updating risk assessments and recourse percentages in real-time as new transactions occur or credit limits are adjusted. This ensures a robust framework for managing credit risk and liability, providing clear accountability and minimizing disputes over financial responsibility in cases of default.

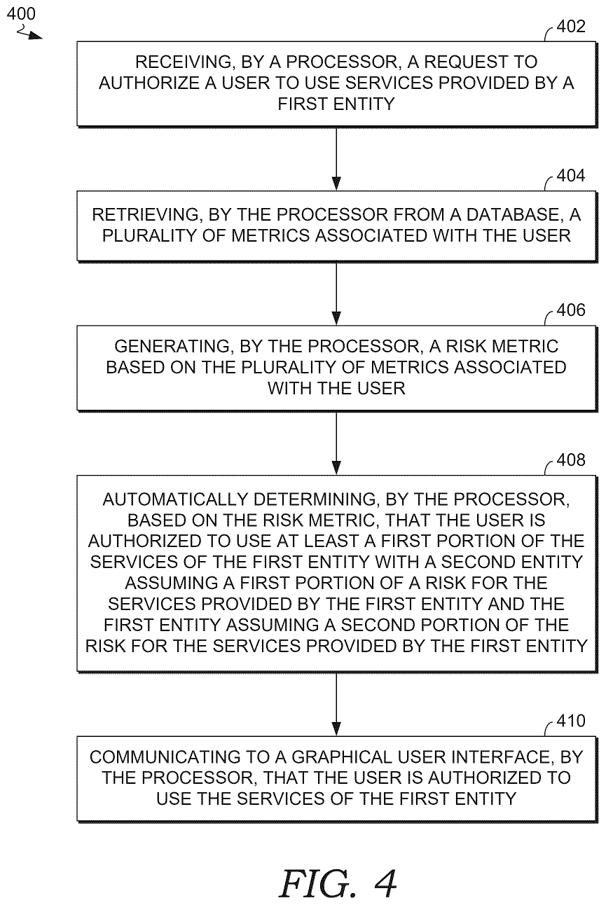

FIG. 4 illustrates an example method 400 for processing a credit application, in accordance with an aspect described herein. At block 402, a processor within the system receives a request to authorize a user for accessing and using services provided by a first entity. This request typically originates from the user or a system acting on behalf of the user. The processor acts as the central point for handling and processing these authorization requests, ensuring the secure and seamless provision of services to the user. Upon receiving the request, the processor initiates the necessary procedures to validate the user's credentials, permissions, and eligibility to access the services offered by the first entity. This may involve checking user authentication, verifying account details, evaluating user roles and permissions, and cross-referencing with relevant databases or authorization rules. The processor plays a crucial role in enabling a smooth and efficient authorization process, ensuring that only authorized users gain access to the application.

At block 404, the processor retrieves a plurality of metrics associated with the user from a database. This step involves accessing a structured database that stores user-related information and metrics relevant to the authorization and evaluation process. The processor queries the database using the user's unique identifier or other identification parameters to retrieve the specific metrics associated with that user. These metrics can include a wide range of data points, such as historical usage patterns, transaction history, account balances, performance metrics, risk scores, or any other relevant metrics associated with the user's interactions with the first entity's services. By retrieving these metrics, the processor gains valuable insights into the user's past behavior and performance, enabling a more comprehensive evaluation and decision-making process during the authorization and service provisioning stages.

At block 406, the processor generates a risk metric based on the plurality of metrics associated with the user. This step involves analyzing and processing the retrieved metrics to assess the level of risk associated with authorizing the user for the services provided by the first entity. The processor applies predefined algorithms, rules, or machine learning models to the collected metrics, taking into account various factors such as historical behavior, financial data, performance indicators, and any other relevant metrics. The generated risk metric serves as a quantifiable representation of the user's creditworthiness, trustworthiness, or overall risk level. It provides an objective measure that helps in evaluating the user's eligibility for accessing the services and informs decision-making processes related to the authorization. The risk metric can take different forms depending on the specific requirements and models used. It may be a numerical score, a risk category or level, or a combination of factors that contribute to an overall risk assessment. This metric assists in determining the user's suitability for accessing the services, considering factors such as its ability to meet financial obligations, adherence to compliance standards, past performance, and potential risk factors. By generating a risk metric based on the user's metrics, the processor enables a systematic evaluation of the user's risk profile. This metric helps the processor make informed decisions regarding the authorization process, balancing the need to provide access to services while mitigating potential risks associated with the user.

At block 408, the processor automatically determines, based on the generated risk metric, that the user is authorized to use at least a first portion of the services provided by the first entity. This authorization decision takes into account a risk-sharing agreement between the first and second entities. Specifically, the processor evaluates the user's risk metric, previously generated at block 406, to assess the user's level of risk. This risk metric is crucial for determining the user's eligibility and suitability for accessing the services. The processor compares this risk metric against predefined risk thresholds or policies that have been collaboratively established by both entities. These thresholds specify the proportion of risk that the second entity is prepared to assume and the portion of risk that remains with the first entity. If the user's risk metric aligns with these thresholds, indicating that the risk levels are within acceptable limits as agreed upon by both entities, the processor authorizes the user to access the first portion of services. Here, the second entity assumes a predetermined first portion of the risk, while the first entity retains a second portion of the risk. This division of risk allows the first entity to offer services to the user under the security that the second entity will share the financial responsibility for potential losses or consequences arising from the user's use of the services.

Following the initial authorization process, the system can manage and assign credit risk associated with various user transactions. At subsequent points, once the user begins to utilize the authorized services, each transaction or purchase made under the services of the first entity is carefully evaluated and assigned a specific risk assumption portion. This assignment is directly influenced by the previously determined risk metric and the risk-sharing agreements in place between the first and second entities.

For each transaction, the processor calculates and assigns a distinct recourse percentage that correlates with the risk levels previously agreed upon. The recourse percentage determines the extent to which each entity-first or second-is responsible for the risk associated with that particular transaction. If the user makes a first purchase, the processor assigns a first recourse percentage based on the initial risk portion that the second entity agreed to assume, and a second recourse percentage based on the risk retained by the first entity. As the user continues to access further services and makes additional purchases, similar assessments are conducted for each transaction. The risk assessment is calculated based on the risk assumed by each entity at that period in time. For example, if the risk assumed by each entity is 50/50 at a first period, then the risk assessment is 50/50 for purchases at that period of time. Additionally, if the risk assumed changes at a time in the future, the purchases are then assigned those risk assessment values. As an example, if the risk assumed changes to 25/75, then any purchases after that are assigned a 25/75 risk assessment value.

These ongoing assessments ensure that risk is dynamically managed and portioned out according to the specific details of each purchase, in alignment with the overarching risk thresholds and the financial responsibilities as delineated in the user's authorization and credit limits.

At block 410, the processor communicates to a graphical user interface (GUI) that the user is authorized to use the services of the first entity. This step involves providing a clear and user-friendly interface to convey the authorization decision to the user. The processor retrieves the authorization decision made in the previous step (block 408), which determined that the user is authorized to use the services of the first entity. The processor interfaces with a GUI, which is a visual representation of the application or system that the user interacts with. The GUI can be a web application, a mobile app, or any other interface that allows the user to access and utilize the services of the first entity. The processor sends a notification or updates the GUI to indicate that the user has been authorized to use the services. This notification typically includes information about the approved access, the available services, and any relevant terms or conditions. The GUI may visually highlight the authorized status, such as displaying a confirmation message, changing the status indicator to reflect authorization, or providing access to previously restricted features or functionalities. Once the authorization is communicated, the user gains full or limited access to the services provided by the first entity, depending on the specific authorization decision and the associated permissions granted. The GUI ensures that the communication regarding the authorization is presented in a user-friendly manner. It provides clear and concise information, ensuring that the user understands their authorized access and any associated limitations or requirements.

Embodiments described above are combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present disclosure is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having,” or variations thereof, has the same broad meaning as the word “comprising,” and the word “accessing,” or variations thereof, and comprises “receiving,” “referencing,” or “retrieving.” Further, the word “communicating,” or variations thereof, has the same broad meaning as the word “receiving” or “transmitting” facilitated by software or hardware-based buses, receivers, or transmitters using communication media. Also, the word “initiating” or “invoking,” or variations thereof, has the same broad meaning as the word “executing” or “instructing” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present disclosure are described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present disclosure may generally refer to the distributed data object management system and the described schematics, it is understood that the techniques described may be extended to other implementation contexts.

From the foregoing, it will be seen that the present disclosure may be well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

What is claimed is:

1. One or more non-transitory computer storage media storing computer-readable instructions that, when executed by one or more processors, cause the one or more processors to perform operations for a user application, the operations comprising:
training a machine learning model by:
extracting a set of historical features from historical data comprising past user histories that have been labeled as inspected or not inspected;
converting the set of historical features into one or more representative feature vectors; and
processing the one or more representative feature vectors using the machine learning model to identify a vector space representative of the set of historical features;
subsequent to training the machine learning model:
extracting, by at least one computer processor, a set of features from a plurality of applicant histories, wherein each applicant history of the plurality of applicant histories comprises a feature of an applicant for using a service provided by a first entity;
converting, by the at least one computer processor, the set of features into one or more feature vectors;
processing, by the at least one computer processor, the one or more feature vectors using the machine learning model to generate a prediction for a risk metric associated the applicant, wherein the machine learning model generates the prediction based at least in part on determining a distance, in the vector space, between the one or more feature vectors and the one or more representative feature vectors
automatically determining, by the processor, based on the risk metric, that the applicant is authorized to use a first portion of the service of the first entity with a second entity assuming a first portion of a risk for the service provided by the first entity and the first entity assuming a second portion of the risk for the service provided by the first entity;
assigning a first recourse percentage to a first purchase based on the first portion of the risk and a second recourse percentage to the purchase based on the second portion of the risk;
receiving a second request to use a second portion of services provide by the first entity;
automatically determining based on the risk metric, that the applicant is authorized to use the second portion of the service provide by the first entity, with the second entity assuming a third portion of a risk for the second portion of service provided by the first entity and the first entity assuming a fourth portion of the risk for the second portion of the service provided by the first entity;
assigning a third recourse percentage for a second purchase based on the third portion of the risk and a fourth recourse percentage based on the fourth portion of the risk.

2. The one or more computer storage media of claim 1, wherein the set of historical features includes data points selected from a group consisting of payment history, credit usage, account balances, and duration of credit history.

3. The one or more computer storage media of claim 1, further comprising updating the machine learning model periodically based on one or more additional applicant histories.

4. The one or more computer storage media of claim 1, wherein the automatically determining that the applicant is authorized to use a portion of the service includes a secondary validation process to double-check the risk metric against external credit risk databases.

5. The one or more computer storage media of claim 1, wherein the service provide by the first entity includes financial credit services.

6. The one or more computer storage media of claim 1, further comprising an automated appeal process if the applicant is initially denied service usage.

7. The one or more computer storage media of claim 1, wherein the first entity is a financial institution and the second entity is a merchant.

8. The one or more computer storage media of claim 1, further comprising recalculating the risk metric and updating a service authorization if a financial behavior of the applicant changes.

9. The one or more computer storage media of claim 1, further comprising assigning risk portions and recourse percentages for one or more additional purchases beyond the first purchase, based on the risk metric, where the risk and percentages are dynamically adjusted according to an ongoing applicant behavior.

10. The one or more computer storage media of claim 1, further comprising the first entity and the second entity assuming a bad debt following a default by the applicant based on one or more assigned risk portions to each of the first entity and the second entity.

11. A method for an application performed by one or more processors, the method comprising:
processing one or more feature vectors using the machine learning model to generate a risk metric associated an applicant;
automatically determining, by the processor, based on the risk metric, that the applicant is authorized to use a first portion of a service of a first entity with a second entity assuming a first portion of a risk for the service provided by the first entity and the first entity assuming a second portion of the risk for the service provided by the first entity;
assigning a first recourse percentage to a first purchase based on the first portion of the risk and a second recourse percentage to the purchase based on the second portion of the risk;
receiving a second request to use a second portion of service provide by the first entity;
automatically determining based on the risk metric, that the applicant is authorized to use the second portion of the service provide by the first entity, with the second entity assuming a third portion of a risk for the second portion of service provided by the first entity and the first entity assuming a fourth portion of the risk for the second portion of the service provided by the first entity;
assigning a third recourse percentage for a second purchase based on the third portion of the risk and a fourth recourse percentage based on the fourth portion of the risk.

12. The method of claim 11, wherein the risk metric is based on a weighted evaluation of the plurality of metrics associated with the applicant.

13. The method of claim 11, wherein the machine learning model is specifically a neural network configured to process temporal and transactional data of the applicant to generate the risk metric.

14. The method of claim 11, wherein the one or more feature vectors include data derived from historical data for the applicant, including payment timeliness, frequency of service usage, and financial transaction amounts.

15. The method of claim 11, wherein the second entity assumes the risk by guaranteeing a payment or assuming a liability for an authorized user.

16. The method of claim 11, wherein the authorization decision is determined based on predefined risk thresholds set by the second entity.

17. A system comprising:
a processor; and
one or more computer storage media storing computer-readable instructions thereon that, when executed by the at least one processor, cause the at least one processor to:
generate a risk metric associated an applicant based on a plurality of metrics associated with the applicant;
automatically determine based on the risk metric, that the applicant is authorized to use a first portion of a service of a first entity with a second entity assuming a first portion of a risk for the service provided by the first entity and the first entity assuming a second portion of the risk for the service provided by the first entity;
assigning a first recourse percentage to a first purchase based on the first portion of the risk and a second recourse percentage to the purchase based on the second portion of the risk;
receiving a second request to use a second portion of services provide by the first entity;
automatically determine based on the risk metric, that the applicant is authorized to use the second portion of a service provide by the first entity, with the second entity assuming a third portion of a risk for the second portion of service provided by the first entity and the first entity assuming a fourth portion of the risk for the second portion of the service provided by the first entity; and
assign a third recourse percentage for a second purchase based on the third portion of the risk and a fourth recourse percentage based on the fourth portion of the risk.

18. The system of claim 17, further comprising monitoring an authorized user's usage of the service and adjusting the authorization decision based on their behavior and compliance with one or more service terms.

19. The system of claim 17, wherein the plurality of metrics associated with the applicant is periodically updated.

20. The system of claim 17, wherein the authorization decision is automatically reevaluated in response to a change in the plurality of metrics associated with the applicant.
